(19) United States
(12) Patent Application Publication
(10) Pub. No.: US 2019/0100062 A1
(43) Pub. Date: Apr. 4, 2019

(54) SCREW-IN VALVE CONNECTOR

(71) Applicant: Mould Flying Industrial Co., Ltd., Taichung City (TW)

(72) Inventor: Chia-Hung Kuo, Taichung City (TW)

(73) Assignee: Mould Flying Industrial Co., Ltd.

(21) Appl. No.: 15/720,978

(22) Filed: Sep. 29, 2017

(51) Int. Cl. B60C 29/04; B60S 5/04; F16K 15/20; F16K 24/02

(52) U.S. Cl. CPC B60C 29/04; B60S 5/04; F04B 33/005; F16K 24/02; F16K 15/207

(57) ABSTRACT

A screw-in valve connector includes a stationary connecting pipe with a pipe body and a drive portion. The pipe body includes an air intake portion, an air discharge portion, and a receiving hole. An elastic member is disposed in the receiving hole, and includes: a press end pressed against the air intake portion, and a force-receiving end. A stop includes: a lower end inserted in the force-receiving end, a stop end, an engaging portion between the lower and stop ends to stop against the force-receiving end, and an air passage penetrating the lower and stop ends. A positioning ring is sleeved onto the stop end to abut against the engaging portion, and includes a first threaded hole for threaded connection of a French valve. A rotary ring is pivotally connected to the air discharge portion, and includes a second threaded hole for threaded connection of an American valve.

### BACKGROUND OF THE INVENTION

### Field of the Invention

The present invention relates to a valve connector, and more particularly to a screw-in valve connector.

### Related Prior Art

There are various tire valves, among them, the French valve and the American valve are most common. An ordinary valve connector cannot be directly inserted into the French valve or American valve to inflate the tire, so the user has to watch if the tire valve is French or American, and then choose a suitable valve connector accordingly. To inflate a tire with a French valve, it has to connect a French valve connector to the American valve connector due to the use of an American valve is more common than the use of a French one. Besides, there are many types of valve connectors with forms and shapes, so the valve connector is likely to be interfered by the spokes of the tire when it is assembled onto the valve, which is more inconvenient for the valve connector to be connected to the valve.

Therefore, a valve connector suitable for both America and French valves is disclosed in Taiwan Patent No. 1571579, which comprises a pulling rod which is disposed on the housing of the valve connector and connected to the interior components, when the valve connector is not in use, the pulling rod is in the horizontal position and can be pulled between a release position and a fixed position. However, the tight connection of the spokes to the wheel results in a small installation space for installing the valve connector onto the valve. The pulling rod is likely to be interfered with the spokes when assembling the valve connector to the valve, which is inconvenient for the pulling rod to be pulled from the release position to the fixed position, and pressing the pulling rod is likely to cause deformation of the front end of the valve connector, this design is prone to leakage or loose. Besides, the user needs extra space to operate the pulling rod, which substantially increases the difficulty of installation.

Since the American valve connector is more common than the French one,

The present invention has arisen to mitigate and/or obviate the afore-described disadvantages.

### SUMMARY

One objective of the present invention is to provide a screw-in valve connector which can be easily connected to the valve.

Therefore, a screw-in valve connector in accordance with the present invention comprises:

a stationary connecting pipe including a pipe body and a drive portion, wherein the pipe body includes an air intake portion at one end, an air discharge portion at another end thereof, and a receiving hole running through the air intake portion and the air discharge portion, the air intake portion includes an air inlet in communication with the receiving hole, and the drive portion is located on an outer annular surface of the pipe body;

an elastic member disposed in the receiving hole, and including a press end pressed against the air intake portion and a force-receiving end opposite the press end;

a stop including a lower end inserted in the force-receiving end, a stop end opposite the lower end, an engaging portion located between the lower end and the stop end to stop against the force-receiving end, and an air passage penetrating the lower end and the stop end, wherein the elastic member provides an elastic force for the engaging portion to push the stop toward the air discharge portion, and the air passage is in communication with the receiving hole;

a positioning ring sleeved onto the stop end to abut against the engaging portion, and including a first threaded hole for threaded connection of a French valve; and

a rotary ring pivotally connected to the air discharge portion, and including a second threaded hole for threaded connection of an American valve.

The advantage of the present invention is that the configuration of the invention does not require extra operation space, so that the invention won't be interfered with the spokes of the tire, and can therefore be easily assembled to the valve.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is an exploded view of a screw-in valve connector in accordance with a first preferred embodiment of the present invention;

FIG. 2 is an assembly view of the screw-in valve connector in accordance with the first preferred embodiment of the present invention;

FIG. 3 is a cross sectional view of the screw-in valve connector in accordance with the first preferred embodiment of the present invention;

FIG. 4 is a cross sectional view showing that the screw-in valve connector in accordance with the first preferred embodiment of the present invention is screwed with an American valve;

FIG. 5 is a cross sectional view showing that the screw-in valve connector in accordance with the first preferred embodiment of the present invention is screwed with a French valve;

FIG. 6 is an exploded view of a screw-in valve connector in accordance with a second preferred embodiment of the present invention;

FIG. 7 is an assembly view of the screw-in valve connector in accordance with the second preferred embodiment of the present invention;

FIG. 8 is a cross sectional view showing that the screw-in valve connector in accordance with the second preferred embodiment of the present invention is screwed with an American valve; and

FIG. 9 is a cross sectional view showing that the screw-in valve connector in accordance with the second preferred embodiment of the present invention is screwed with a French valve.

### DETAILED DESCRIPTION

The present invention will be clearer from the following description when viewed together with the accompanying drawings, which show, for purpose of illustrations only, the preferred embodiment in accordance with the present invention.

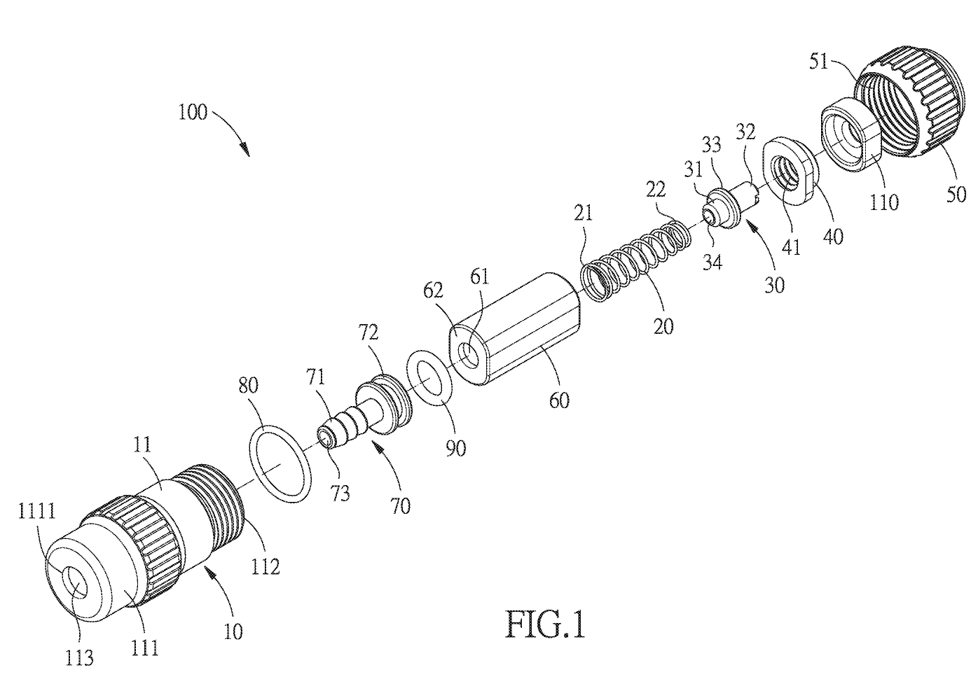

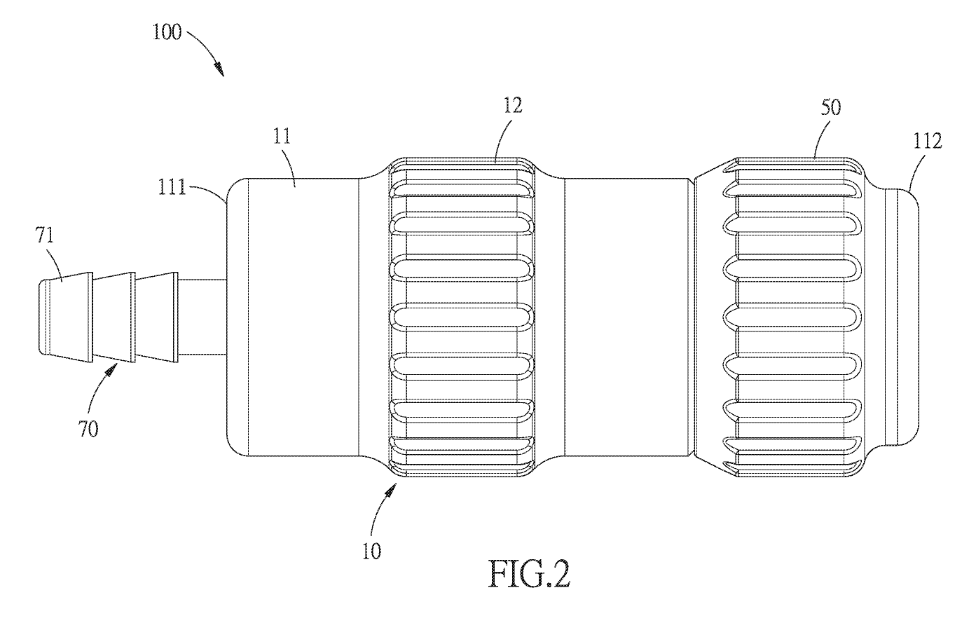

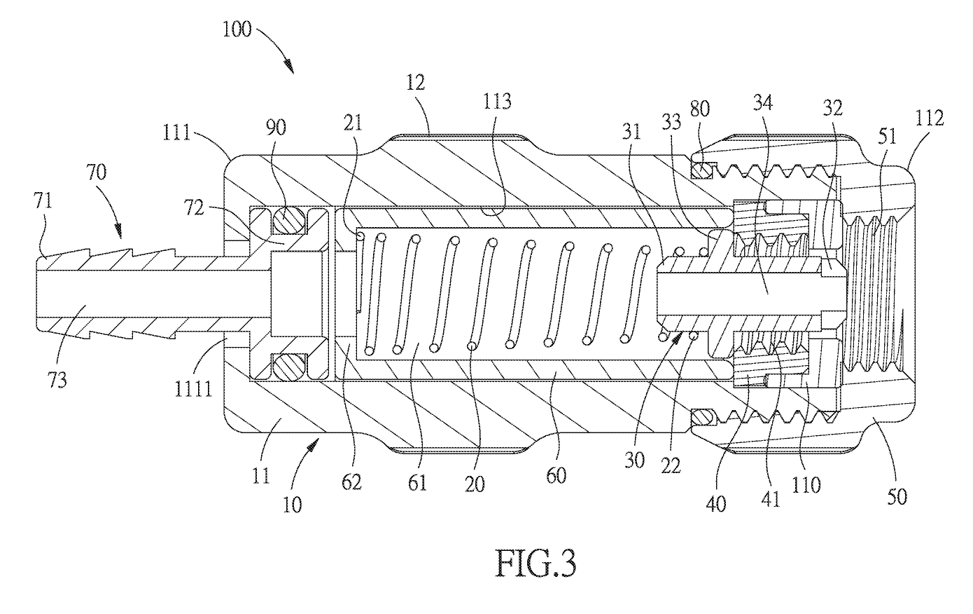

Referring to FIGS. 1-3, a screw-in valve connector 100 in accordance with the first preferred embodiment of the present invention comprises: a stationary connecting pipe 10, an elastic member 20, a stop 30, a positioning ring 40, a rotary ring 50, a pipe connecting member 60 and an airtight seal ring 110.

The stationary connecting pipe 10 has a straight shape, and includes a pipe body 11 and a drive portion 12. The pipe body 11 includes an air intake portion 111 at one end, an air discharge portion 112 at another end thereof, and a receiving hole 113 running through the air intake portion 111 and the air discharge portion 112. The air intake portion 111 includes an air inlet 1111 in communication with the receiving hole 113, and the drive portion 12 is located on an outer annular surface of the pipe body 11.

The elastic member 20 is disposed in the receiving hole 113, and includes a press end 21 pressed against the air intake portion 111 and a force-receiving end 22 opposite the press end 21.

The stop 30 includes a lower end 31 inserted in the force-receiving end 22 of the elastic member 20, a stop end 32 opposite the lower end 31, an engaging portion 33 located between the lower end 31 and the stop end 32 to stop against the force-receiving end 22, and an air passage 34 penetrating the lower end 31 and the stop end 32. The elastic member 20 provides an elastic force for the engaging portion 33 to push the stop 30 toward the air discharge portion 112. The air passage 34 is in communication with the receiving hole 113.

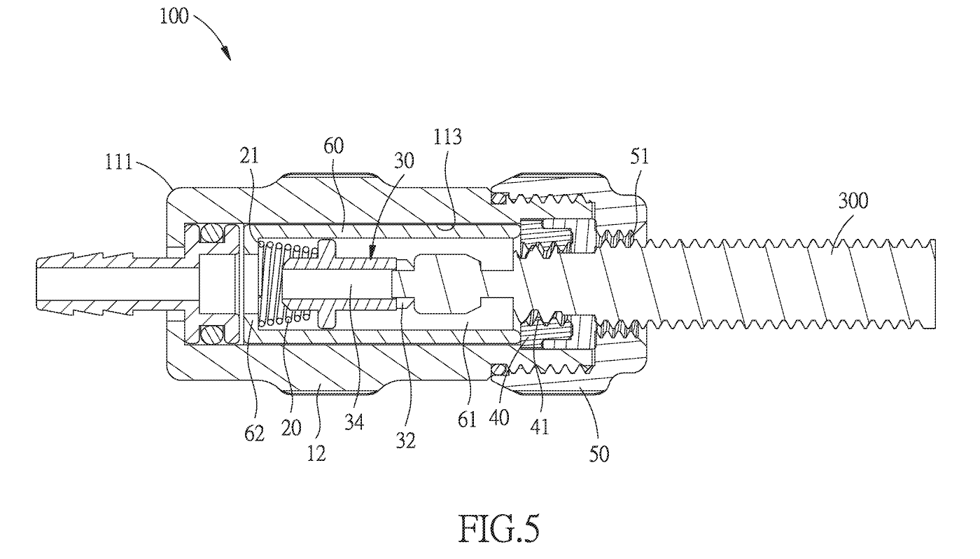

The positioning ring 40 is sleeved onto the stop end 32, abutted against the engaging portion 33, and includes a first threaded hole 41 for threaded connection of a French valve 300, as shown in FIG. 5.

The rotary ring 50 is pivotally connected to the air discharge portion 112, and includes a second threaded hole 51 for threaded connection of an American valve.

The invention further comprises a valve seal ring 110 which is made of synthetic rubber and disposed between the positioning ring 40 and the air discharge portion 112.

The invention further comprises a cylindrical pipe 60 inserted in the receiving hole 113. The cylindrical pipe 60 includes an air hole 61 axially penetrating the receiving hole 113 and provided for accommodation of the elastic member 20, and a cylindrical end 62 inserted in the air hole 61 to press against the press end 21 of the elastic member 20.

The invention further comprises a pipe connecting member 70 which includes: a pipe connecting end 71, an airtight seal end 72 opposite the pipe connecting end 71, and a pipe connecting passage 73 penetrating the pipe connecting end 71 and the airtight seal end 72. The airtight seal end 72 is airtightly disposed in the receiving hole 113 and abutted against the cylindrical end 62 of the cylindrical pipe 60. The pipe connecting end 71 extends out of the air inlet 1111 to communicate with the receiving hole 113. The outer annular surface of the pipe connecting end 71 of the pipe connecting member 70 is a threaded portion.

Besides, a first airtight ring 80 and a second airtight ring 90 are disposed between the press end 21 of the elastic member 20 and the air intake portion 111 to provide a better airtight sealing effect.

What mentioned are the structural relations of the components of the screw-in valve connector in accordance with the present invention, and for a better understanding of the operation of the invention, reference should be made to the following description.

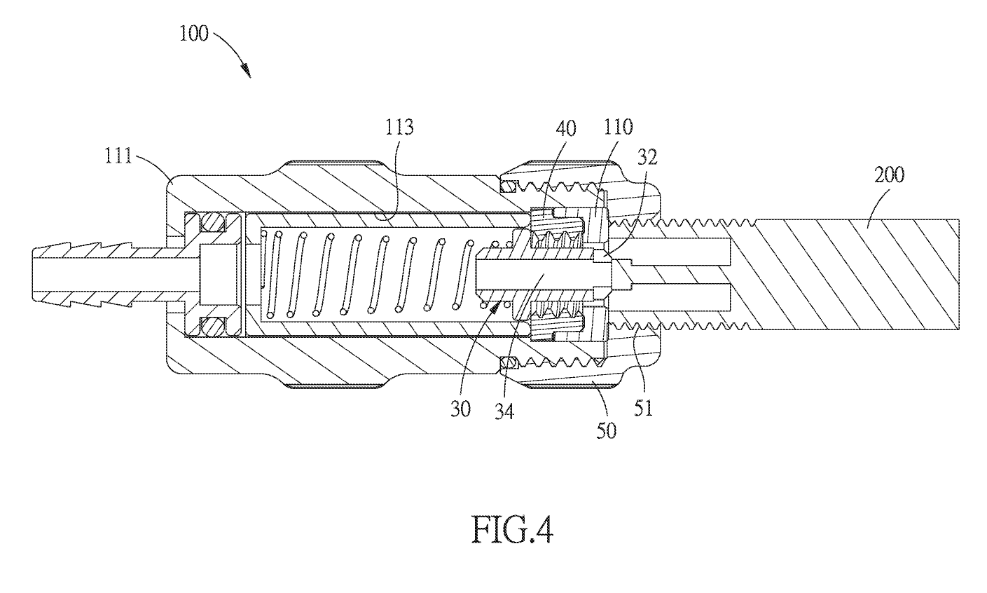

When the invention is used in combination with an American valve 200, as shown in FIG. 4, the second threaded hole 51 of the rotary ring 50 comes into contact with the American valve 200, the user rotates the rotary ring 50 until the outer threaded portion of the American valve 200 is screwed in the second threaded hole 51 of the rotary ring 50 and airtightly stopped against the valve seal ring 110. The valve seal ring 110 is pressed against the positioning ring 40, so that the American valve 200 is fixed in the second threaded hole 51 and stops moving forward. At this moment, the stop end 32 of the stop 30 is airtightly pressed against the American valve 200, so that air pumped from an inflating device can be pumped through the air intake portion 111, the receiving hole 113 and the air passage 34 into the American valve 200 so as to complete the air inflation operation. Besides, the outer threaded portion of the American valve 200 is screwed in the second threaded hole 51 of the rotary ring 50, which can guarantee that the screw-in valve connector 100 of the invention won't be disengaged from the American valve 200 during the air inflating process.

When the air inflation operation is finished, the screw-in valve connector of the invention can be removed from the American valve 200 by rotating the rotary ring 50 reversely.

When the invention is used in combination with a French valve 300, as shown in FIG. 5, the French valve 300 is firstly inserted through the second threaded hole 51 of the rotary ring 50 until an outer threaded portion of the French valve 300 comes into contact with the first threaded hole 41, and then the user rotates the drive portion 12 to screw the outer threaded portion of the French valve 300 into the first threaded hole 41 in a tight manner. Meanwhile, the French valve 300 will push the stop end 32 of the stop 30, and the stop 30 pushes the elastic member 20 toward the cylindrical end 62 to make the press end 21 of the elastic member 20 press against the cylindrical end 62 of the cylindrical pipe 60. When screwed tightly, the French valve 300 is fixed in the air hole 61 of the cylindrical pipe 60 and stops moving forward, so that air from the inflating device can be pumped through the air intake portion 111, the receiving hole 113 and the air passage 34 into the French valve 300 so as to complete the air inflation operation. Besides, the outer threaded portion of the French valve 300 is screwed in the first threaded hole 41, which can guarantee that the screw-in valve connector 100 of the invention won't be disengaged from the French valve 300 during the air inflating process.

When the air inflation operation is finished, the screw-in valve connector of the invention can be removed from the French valve 300 by rotating the drive portion 12.

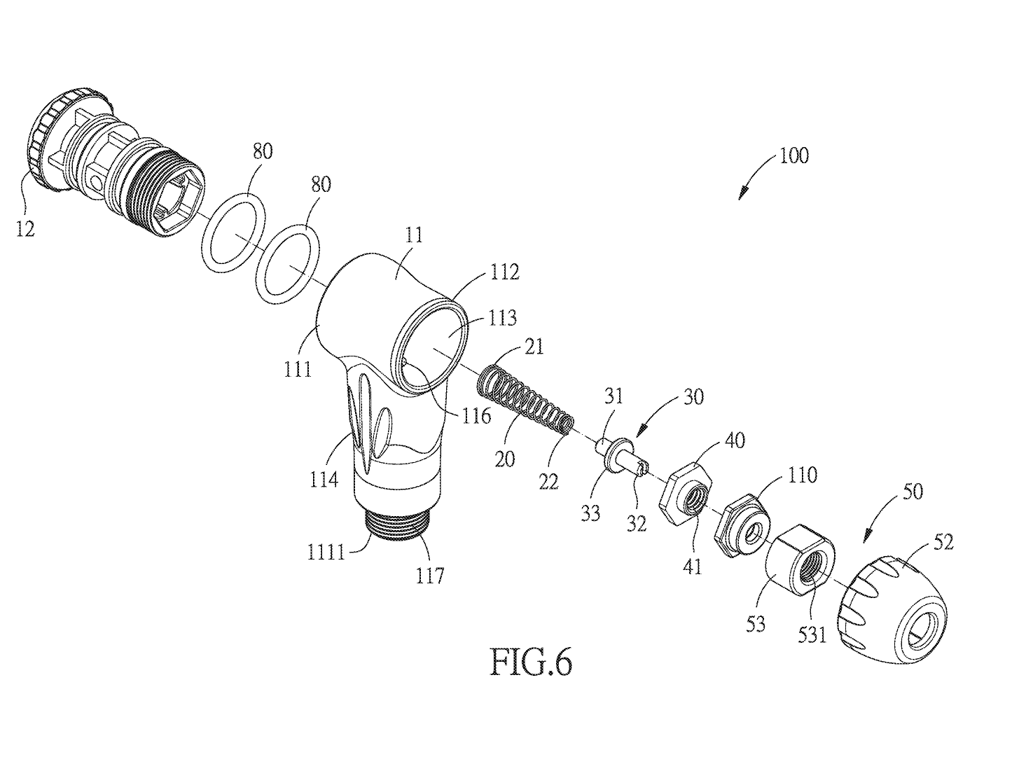

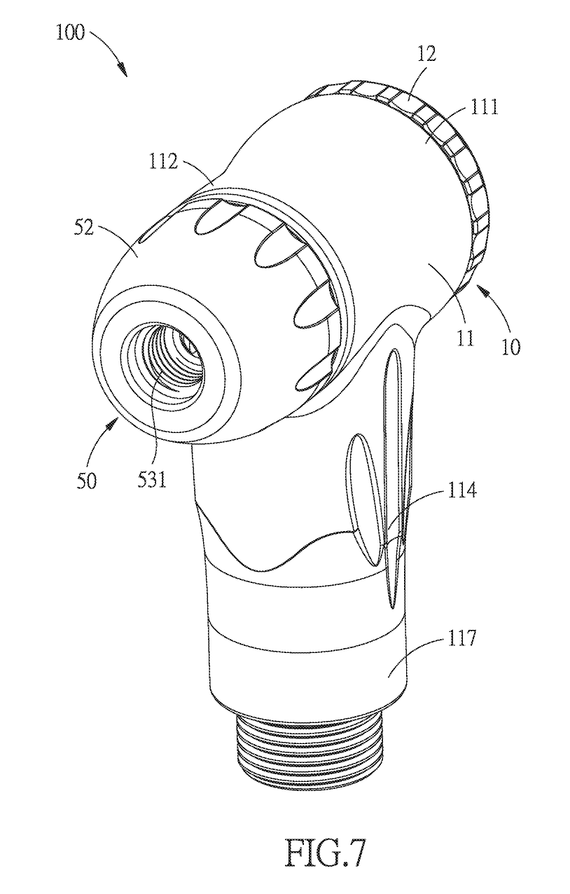

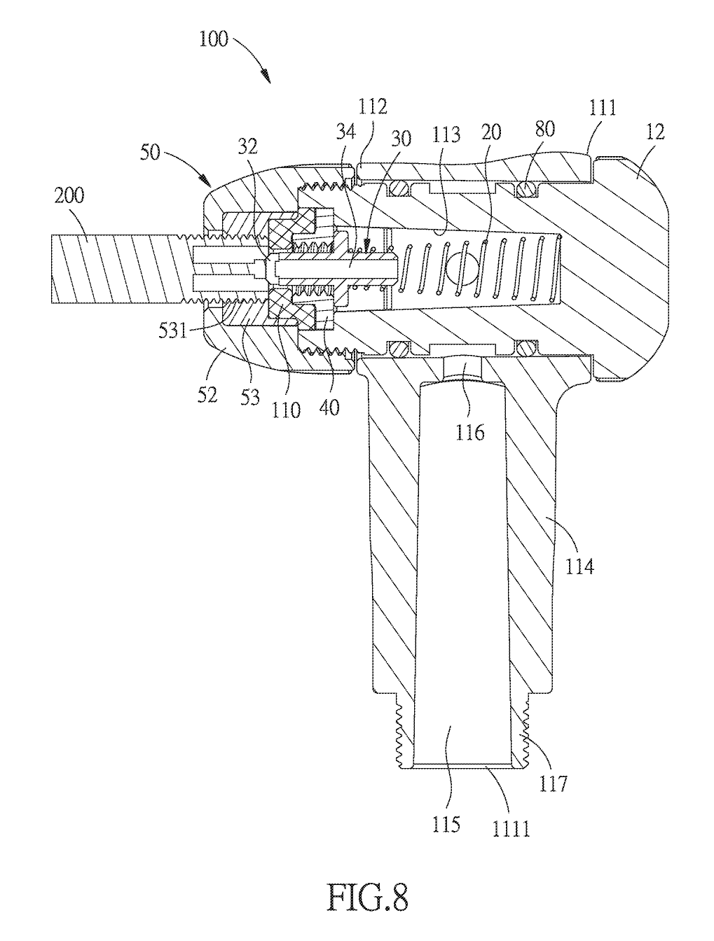

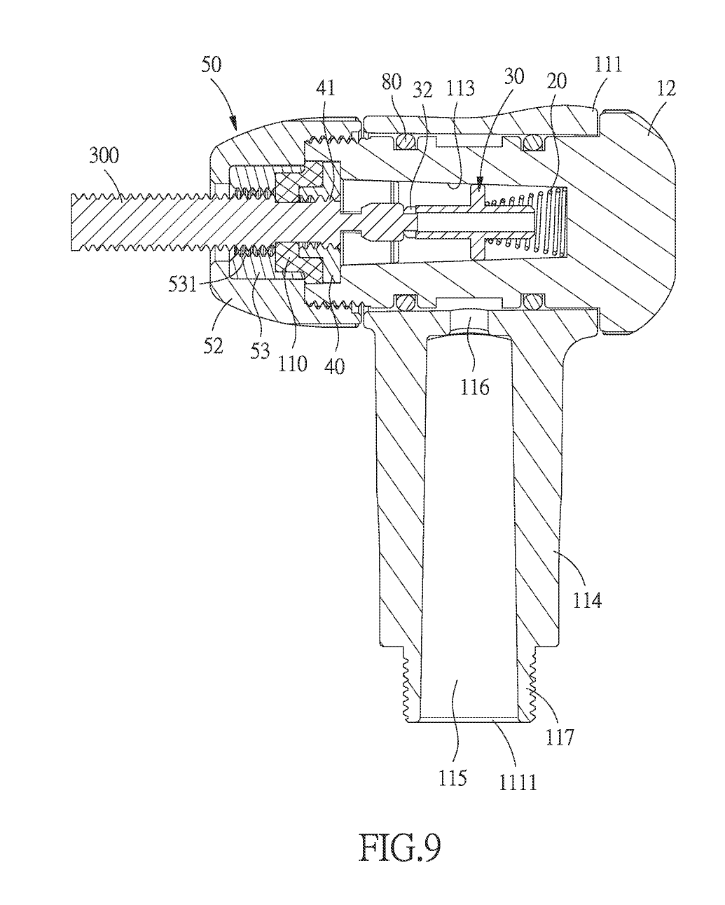

Referring then to FIGS. 6-9, a screw-in valve connector 100 in accordance with the second preferred embodiment of the present invention is similar to the first embodiment, also comprises: a stationary connecting pipe 10, an elastic member 20, a stop 30, a positioning ring 40, a rotary ring 50, and an airtight seal ring 110, except that:

The stationary connecting pipe 10 is L-shaped, and includes a handle 114 disposed at one side of the stationary connecting pipe 10 and located between the air intake portion 111 and the air discharge portion 112. An air intake passage 115 is formed in the handle 114 and penetrates two ends of the handle 114. One end of the air intake passage 115 is connected to the receiving hole 113 to form an opening 116, and another end of the air intake passage 115 is provided with a connecting portion 117. The rotary ring 50 includes a first rotary member 52 and a second rotary member 53 disposed in the first rotary member 52. Rotating the first rotary member 52 can drive the second rotary member 53 to rotate, which consequently causes the American threaded hole 531 of the second rotary member 53 to come into contact with the American valve 200.

It is to be noted that the present invention has the following advantages:

1. tight connection: the present invention is a screw-in valve connector which is connected to the valve of the tire in a screwed manner, so that, during air inflating operation, the tight connection between the valve connector and the valve can prevent air leakage or prevent the valve connector from coming loose from the valve when the air pressure is too high.

2. No adaptor is required: the screw-in valve connector of the invention is suitable for both America and French valves 200, 300, so that the user can connect the valve connector directly to the valve, without distinguishing the type of the valve.

3, easy to assemble: the conventional valve connector is provided with the pulling rod on the housing, and the pulling rod is prone to being interfered with the spokes. The configuration of the invention does not require extra operation space, so that the invention won't be interfered with the spokes of the tire, and can therefore be easily assembled to the valve.

While we have shown and described various embodiments in accordance with the present invention, it is clear to those skilled in the art that further embodiments may be made without departing from the scope of the present invention.

1. A screw-in valve connector, comprising:
a stationary connecting pipe including a pipe body and a drive portion, wherein the pipe body includes an air intake portion at one end, an air discharge portion at another end thereof, and a receiving hole running through the air intake portion and the air discharge portion, the air intake portion includes an air inlet in communication with the receiving hole, and the drive portion is located on an outer annular surface of the pipe body;
an elastic member disposed in the receiving hole, and including a press end pressed against the air intake portion and a force-receiving end opposite the press end;
a stop including a lower end inserted in the force-receiving end, a stop end opposite the lower end, an engaging portion located between the lower end and the stop end to stop against the force-receiving end, and an air passage penetrating the lower end and the stop end, wherein the elastic member provides an elastic force for the engaging portion to push the stop toward the air discharge portion, and the air passage is in communication with the receiving hole;
a positioning ring sleeved onto the stop end to abut against the engaging portion, and including a first threaded hole for threaded connection of a French valve; and
a rotary ring pivotally connected to the air discharge portion, and including a second threaded hole for threaded connection of an American valve;
wherein the stationary connecting pipe has a straight shape and further includes a cylindrical pipe inserted in the receiving hole, the cylindrical pipe includes: an air hole axially penetrating the receiving hole and provided for accommodation of the elastic member; a cylindrical end inserted in the air hole to press against the press end of the elastic member; and a pipe connecting member which includes: a pipe connecting end, an airtight seal end opposite the pipe connecting end, and a pipe connecting passage penetrating the pipe connecting end and the airtight seal end, the airtight seal end is airtightly disposed in the receiving hole and abutted against the cylindrical end of the cylindrical pipe, and the pipe connecting end extends out of the air inlet to communicate with the receiving hole.

2-4. (canceled)

5. The screw-in valve connector as claimed in claim 1, wherein an outer annular surface of the pipe connecting end of the pipe connecting member is a threaded portion.

6. The screw-in valve connector as claimed in claim 1 further comprising a valve seal ring which is made of synthetic rubber and disposed between the positioning ring and the air discharge portion.

7. A screw-in valve connector, comprising:
an L-shaped stationary connecting pipe including a pipe body and a drive portion, wherein the pipe body includes an air intake portion at one end, an air discharge portion at another end thereof, and a receiving hole running through the air intake portion and the air discharge portion, the air intake portion includes an air inlet in communication with the receiving hole, and the drive portion is located on an outer annular surface of the pipe body;
an elastic member disposed in the receiving hole, and including a press end pressed against the air intake portion and a force-receiving end opposite the press end;
a stop including a lower end inserted in the force-receiving end, a stop end opposite the lower end, an engaging portion located between the lower end and the stop end to stop against the force-receiving end, and an air passage penetrating the lower end and the stop end, wherein the elastic member provides an elastic force for the engaging portion to push the stop toward the air discharge portion, and the air passage is in communication with the receiving hole;
a positioning ring sleeved onto the stop end to abut against the engaging portion, and including a first threaded hole for threaded connection of a French valve; and
a rotary ring pivotally connected to the air discharge portion, and including a second threaded hole for threaded connection of an American valve.
